(19) United States
(12) Patent Application Publication
(10) Pub. No.: US 2015/0264869 A1
(43) Pub. Date: Sep. 24, 2015

(54) Urn and planter assembly

(71) Applicant: Martin Steiner, Vienna (AT)

(72) Inventor: Martin Steiner, Vienna (AT)

(21) Appl. No.: 14/666,222

(22) Filed: Mar. 23, 2015

(30) Foreign Application Priority Data
Mar. 24, 2014 (AT) A 207/2014

(51) Int. Cl. A01G 9/02; A61G 17/08

(52) U.S. Cl. CPC A01G 9/028; A61G 17/08

(57) ABSTRACT

An urn and planter assembly comprises at least two separate chambers (7, 8) and at least one nutrient transmission element (5). The at least one first chamber (7) serves as a receptacle for ashes, in particular cremation ashes. The at least one second chamber (8) serves as a receptacle for a planting matrix. Nutrients can be conveyed from the first chamber (7) into the second chamber (8) through at least one nutrient transmission element (5).

### TECHNICAL FIELD

The invention relates to an urn and planter assembly in which cremation ashes provide a nutritional input for a plant while keeping the ashes and the plant separated.

### BACKGROUND

For as long as humans have practiced the interment of their dead, the careful tending of a grave—decorating it with flowers and plants—has been a fundamental ritual of remembrance. Today, however, cremation is an increasingly popular choice. In some areas more than half of all interments are of cremated remains. The sharp increase in cremations around the world in recent years is partly attributable to the significantly higher costs for a traditional interment in comparison with an urn grave. Aesthetic and hygienic considerations also play a role; a decaying corpse represents a genuine threat to the soil and groundwater. Coffins are also normally painted or lacquered and upholstered with synthetic materials—an ecological problem which has only seeped into the consciousness of cemetery administrators over the past few years. Some people also consider cremation to be a “cleaner” form of disposal in comparison to the decaying of their mortal remains underground, particular if the deceased was afflicted with a communicable disease.

The question of cremation arises not only upon the death of a relative, but also upon the death of a beloved pet. It is now common upon the death of an animal companion to have the remains cremated. However, in the case of cremation, the ritual of tending the grave—an important opportunity for dealing with grief and cultivating remembrance—is largely eliminated: the urn or ash capsule with the cremated remains of the deceased is rarely given its own grave. Ash capsules are normally integrated into plain or decorative urns and immured in columbariums or buried in a cremation burial plot. As such gravesites usually do not permit plantings to be made, the rituals of remembrance are often limited to the placing of cut flowers at the site. The comforting symbolism of growth and blooming available with the tending of traditional burial plots is lost entirely.

For this reason, the bereaved often prefer that the ash capsule or urn not be interred at a public cemetery, but kept at home. This is partly due to a wish to keep the departed close to them even after death, or to be able to bury the remains at a place that holds personal meaning. On the other hand, financial considerations may also play a role, when one considers that a cremation burial plot with a 20-year occupancy period can easily cost several hundred Euros.

Undertakers have noticed another trend in favor of cremation and the practice of keeping the departed's remains at home: as globalization advances, families today are often scattered across multiple countries or even continents. Cremation permits the ashes to be divided among several of the survivors.

In order to eliminate the drawback of the lack of opportunity to tend a gravesite in the case of cremations, it has been suggested in the prior art in US 2008/0083102 A1 that urns or ash capsules be set into the trunk of a tree or another plant (such as a cactus or a palm) such that the remains are gradually enclosed over time and integrated into the plant. In this way, the urn or ash capsule of the departed is “united” with the plant. The disadvantage of this invention, however, is that a sufficiently large plant is required, and that the urn or ash capsule and the enclosed ash remain a foreign body in the plant.

Also known from the prior art is U.S. Pat. No. 5,815,897. This relates to a cachepot for a plant pot which can be attached to an urn e.g. by means of a screw connection. However, this invention also does not provide a direction connection or operative connection. The connection between the urn and the cachepot is of a purely decorative nature.

However, the survivors of the departed often wish that the urn with the cremated remains be not merely stored in or next to a plant for decorative purposes, but that the ashes form a physical union with a plant and thus that the departed “live on” in the form of the plant, or that the growing, flourishing plant symbolize the continuing life of the deceased. Observing the growth of such a plant also “keeps alive” the memory of the departed.

From a scientific perspective, this growth from the ashes of the deceased demonstrates the cycle of matter of life. In a theological sense, it illustrates the idea of “ashes to ashes, dust to dust”, or the principle of reincarnation. The cycle of matter of all life is found in every world religion. It offers a multitude of comforting metaphors for the vital process of coping with the grief and pain of loss.

It is known from the prior art in this regard that ash, in particular ash from cremation, contain a high proportion of substances which can be used by plants as nutrients. In particular, cremation ash has a very high percentage of calcium phosphate, and is thus suited for use as a fertilizer, or as a nutrient additive for plants. Thus, e.g., US 2008/013 4575 A1 discloses the use of cremation ash for fertilizing plants. In it, however, the cremation ash is mixed with, e.g. potting soil.

### SUMMARY

It is an object of the present invention to provide a decorative urn that does not overstep the bounds of respectfulness and piety in which ashes are stored, in particular the cremated remains of humans or animals, and by means of which the nutrients in such ashes are supplied to a plant without the mixing of the ashes and the planting matrix (earth, granulate, etc.). Even during the planting or plant care process, no contact may occur with the solid ashes. The plant draws nutrients from the ashes inside the urn. Through this interaction, the cycle of matter of life is not hindered, as is the case with a standard ash capsule, but promoted.

In accordance with the invention, an urn is therefore provided, comprising at least two areas. The urn may be cylindrical, prismatic, or spherical, but could also have any other basic geometric form imaginable.

It may also be desired that a single urn contain the ashes of several deceased humans or animals. For reasons of respect and piety, however, such a construction should make it possible to ensure that the ashes of multiple deceased persons or animals are not intermingled.

The urn may be made e.g. from ceramics, clay, sandstone, glass, porcelain, plastic, Corian, or any other conceivable material. The urn in accordance with the invention has at least two chambers separated from one another. At least one first chamber of the urn serves to contain ash, in particular cremation ashes. In accordance with the invention, the first chamber of the urn may also comprise several spatially separate partial chambers, so that the first chamber may serve as a receptacle for the ashes of one or more persons or animals. At least one second chamber of the urn may contain a planting matrix. This planting matrix may be any substance suited to providing a basis of existence for a plant. The planting matrix may thus comprise sand, earth, granulate, water, or any other material suitable for promoting the growth of plants.

In accordance with the invention, nutrients from the cremation ashes in at least one chamber of the urn are transported into at least one second chamber of the urn by means of at least one nutrient transmission element. This at least one nutrient transmission element may have any arbitrary shape, e.g. it may be disc-shaped, cylindrical, spherical, or conical. The nutrient transmission element may comprise any porous material capable of functioning as a membrane. The nutrient transmission element may be formed e.g. from clay, ceramic material, sandstone, glass, or plastic. The nutrient transmission element may be formed such that it separates the at least two separate chambers of the urn such that the ash does not come into contact with the planting matrix, or cannot be combined with it.

The nutrient transmission element can also be at least one wicking element or at least one irrigating element. The wicking element is formed such that it extends into the first chamber of the urn and is in physical contact with the cremation ashes contained therein. The wicking element may have any arbitrary form. The wicking element is preferably formed so as to be cylindrical and hollow, with the cylinder preferably open at the base. The wicking element can thus be more easily pressed into the ashes with the open-ended cylinder, and also offers a greater surface for nutrient transport. The wicking element may be formed such that it may be rigidly connected to at least one further nutrient transmission element.

The irrigating element comprises a connection between the area outside the urn and the first chamber of the urn, by means of which water (as from a watering can) for a plant may be conducted to at least one first chamber of the urn. The irrigating element may also be formed such that it can be rigidly connected to at least one further nutrient transmission element.

It is also possible to provide an urn from a porous material than can function as a membrane. In this case, the entire urn functions as a nutrient transmission element.

In one embodiment of the invention, the urn comprises two chambers. Ash is placed in a first chamber of the urn. In a second chamber of the urn, the planting matrix (e.g. earth) and a plant (e.g. a flower) are placed. The two chambers are separated from one another by the nutrient transmission element. If the plant is watered, water or moisture can be slowly transported through the nutrient transmission element or the wicking element from the second chamber to the ashes in the first chamber, e.g. by the force of gravity or in some other way. The moisture penetrates the ashes and dissolves the nutrients therein. If the planting matrix dries out, osmosis and capillary action ensure that the moisture still present in the first chamber of the urn is conveyed into the second chamber via the nutrient transmission element. At the same time, the nutrients contained in the ashes are transported via the nutrient transmission element into the planting matrix in the second chamber of the urn, where they can be absorbed by a plant.

As the nutrient transmission element functions as a membrane, the selection of a specific pore size of the material makes it possible to determine which nutrients or molecules will be conveyed from the ashes to the planting matrix and in what quantity, and which molecules remain in the ashes. The pores are sized in accordance with the invention so as to be large enough to transport the important nutrients from the ash chamber to the potting soil, but small enough to prevent unwanted substances, such as bacteria, from moving from the potting soil in the second chamber into the first chamber. By selecting a particular size and the possible number of nutrient transmission elements, and the pore size of the nutrient transmission element and the wicking element, the quantity of nutrients transported into the planting matrix can also be specified.

For plant species requiring only minimal quantities of nutrients, a material with very small pores is preferably selected, so that only small quantities of nutrients are transported out of the ashes. Furthermore, it is known that, the more nutrients that are transported, the higher the pH level in the planting matrix becomes. Through the selection of the pore size and the size of the nutrient transmission element, overfertilization or a change in the pH value can thus be prevented. For example, orchids require a low pH value, so the nutrient transmission element for such plants should be on the smaller side.

In the urn in accordance with the invention, the pore size of the nutrient transmission element is in the micrometer range. The solid ash thus cannot come into contact with the planting matrix. The respectful separation of ashes and planting matrix is thus at all times preserved. In accordance with the invention, the ashes can be placed into at least one first chamber of the urn directly in the crematorium.

The nutrient transmission element can furthermore be either rigidly connected to the urn, or can be inserted in the urn later.

It is additionally possible to contain the ashes in a separate ash container which is placed in the first chamber of the urn. It can be assured by this means that, in the event of damage to or the shattering of the urn, the ash remains in the ash container, and is not scattered.

It is also conceivable that the urn be provided with a removable glass cover. In this manner, the urn becomes a terrarium for plants. Through evaporation and condensation in the container, moisture thus circulates inside. This form of construction minimizes the amount of care and maintenance needed, and even more directly illustrates the way in which the cremation ashes can form a vital component of an ecosystem.

It is also conceivable that at least one first chamber of the urn that serves as a receptacle for the ashes is located inside the nutrient transmission element. In this embodiment, the first chamber is delimited by the nutrient transmission element.

A further advantageous embodiment of the urn in accordance with the invention provides for water, as from a watering can, to be placed directly in the first chamber of the urn. In it, the water is enriched with nutrients, which are transported via the nutrient transmission element into the planting matrix in the second chamber of the urn.

The invention is explained in greater detail below by means of various embodiments, and with the aid of illustrations.

### BRIEF DESCRIPTION OF THE DRAWINGS

The illustrations depict the following:

FIG. 1 illustrates an urn and planter assembly.

FIG. 2a illustrates an urn and planter assembly with a disc-shaped nutrient transmission element.

FIG. 2b shows a modified embodiment in accordance with FIG. 2a

FIG. 3a shows an urn and planter assembly with a cylindrical nutrient transmission element.

FIG. 3b is an external view of an urn in accordance with FIG. 3a.

FIG. 4a shows an urn and planter assembly with a nutrient transmission element and a wicking element.

FIG. 4b shows a cross-section of an urn in accordance with FIG. 4a.

FIG. 4c shows a modified embodiment in accordance with FIG. 4a.

FIG. 5a illustrates an urn and planter assembly with a wicking element.

FIG. 5b is an external view of an urn in accordance with FIG. 5a.

FIG. 5c is an external view of an urn in accordance with FIG. 5a, with wicking element inserted.

FIG. 5d shows a cross-section of an urn in accordance with FIG. 5a with wicking element inserted.

FIG. 6a shows an urn and planter assembly with an empty ash container in the first section.

FIG. 6b shows a cross-section of an urn in accordance with FIG. 6a with a full ash container.

FIG. 6c shows a cross-section of an urn in accordance with FIG. 6a with a full ash container and wicking element inserted.

FIG. 7a shows an urn and planter assembly with four wicking elements.

FIG. 7b shows an urn and planter assembly with multiple wicking elements.

FIG. 8 shows an urn and planter assembly in which the first chamber comprises two partial chambers, each of which has one wicking element.

FIG. 9a shows a cross-section of an urn and planter assembly in which the first chamber comprises two partial chambers, each of which has one wicking element.

FIG. 9b shows a cross-section of an urn and planter assembly in which the first chamber comprises six partial chambers, each of which has one wicking element.

FIG. 9c is a top view of an urn and planter assembly in accordance with FIG. 9a.

FIG. 9d is a top view of an urn and planter assembly in accordance with FIG. 9b.

FIG. 10a illustrates an urn and planter assembly with a nutrient transmission element that forms and delimits the first chamber of the urn.

FIG. 10b shows a urn and planter assembly with an inserted nutrient transmission element in accordance with FIG. 10a.

FIG. 10c shows a cross-section of an urn in accordance with FIG. 10b.

FIG. 11a shows a special embodiment of the urn in accordance with the invention, in which the first chamber of the urn can be filled with ash through the bottom wall of the urn.

FIG. 11b is a top view of an urn in accordance with FIG. 11a.

FIG. 12a illustrates an urn and planter assembly in accordance with FIG. 5a, having a disc-shaped nutrient transmission element with an opening with a delimiting surface.

FIG. 12b is an exterior view of an urn in accordance with FIG. 12a.

FIG. 13a illustrates an urn and planter assembly in which at least one first chamber is formed by a cavity between the exterior wall and the interior space of the urn.

FIG. 13b is a top view of the urn in accordance with FIG. 13a.

### DETAILED DESCRIPTION

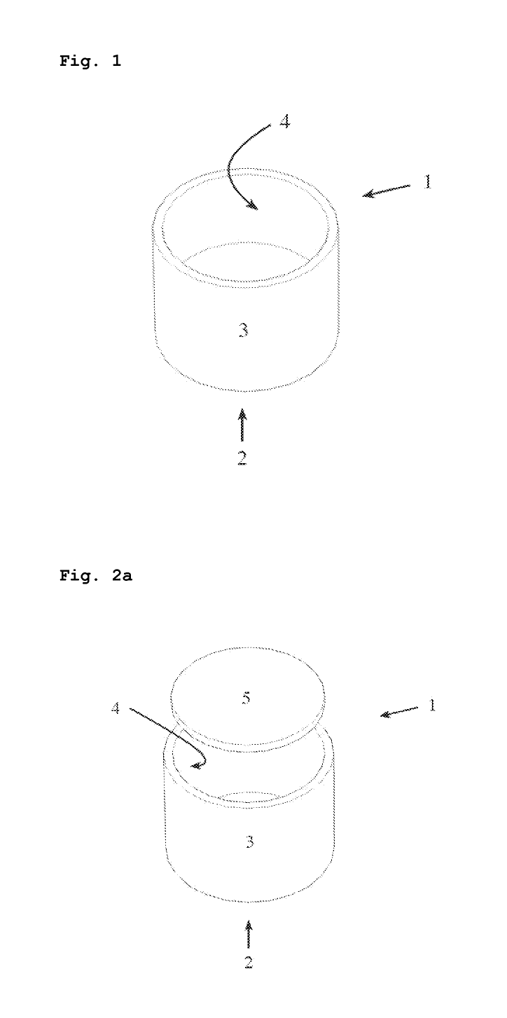

FIG. 1 shows an urn 1 in accordance with the invention with a cylindrical basic form. However, the urn in accordance with the invention is not limited to this basic form, but may have any other imaginable geometrical basic form. The urn and planter assembly 1 has a bottom wall 2 and an exterior wall 3. The urn 1 has an interior space 4 which, in the embodiment depicted here, is delimited by the exterior wall 3 and the bottom wall 2. Depending on the basic geometrical form of the urn, the interior space 4 can also be delimited only by the exterior wall 3, as in the case e.g. of a spherical urn. It is also conceivable that the interior space 4 be delimited by a nutrient transmission element 5. The interior space of the urn 4 has at least one first chamber 7 and a second chamber 8. The first chamber 7 serves as a receptacle for ashes, in particular cremation ashes. The second chamber 8 serves to contain a planting medium and a plant.

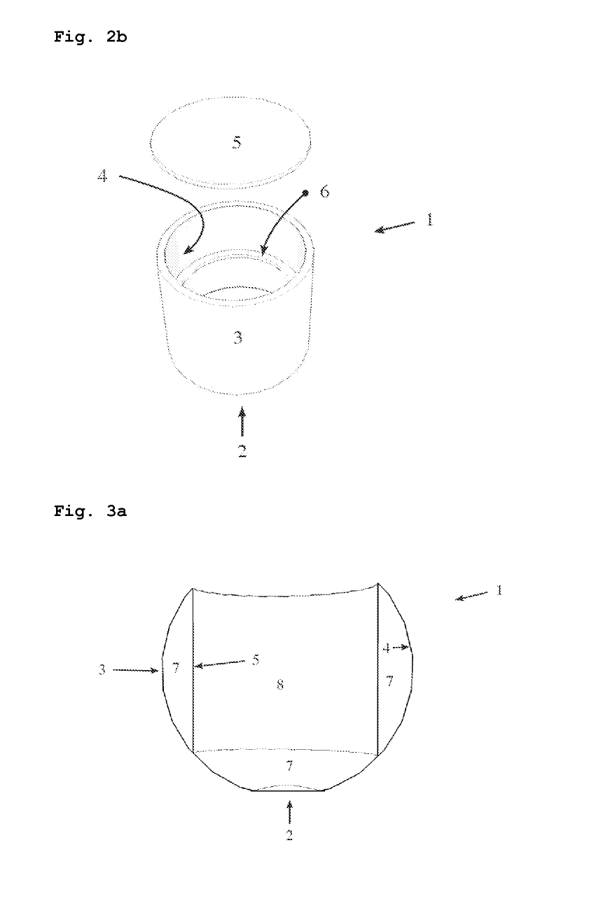

FIG. 2a depicts an urn 1 and a nutrition transmission element 5. The nutrition transmission element 5 is formed disc-shaped in the embodiment depicted in FIG. 2a. The nutrition transmission element 5 preferably has a diameter largely corresponding to the diameter of the interior space 4 of the urn 1. In this way, it is ensured that the nutrition transmission element 5 can be inserted into the urn 1 so that it fits snugly against the inner side of the exterior wall 3 and thus creates two chambers inside the interior space 4 of the urn 1. In this embodiment, the entire surface of the nutrition transmission element 5 serves to convey nutrients between the at least two chambers of the urn 1.

In the embodiment of the urn in accordance with the invention in accordance with FIG. 2a, the nutrition transmission element 5 sits directly on top of the ash contained in the first chamber 7. The planting matrix is then placed directly on the nutrient transmission element 5. If the plant in this embodiment is watered, the water conveys the nutrients contained in the ashes through the disc-shaped nutrient transmission element into the planting matrix, from which they can be absorbed by the plant. The nutrient transmission element is formed such that only the nutrients are transported, but the ashes themselves do not come into contact with the planting matrix.

FIG. 2b depicts an especially advantageous embodiment of an urn in the embodiment in accordance with FIG. 2a. In this embodiment, a projection 6 extends radially along the inner side of the exterior wall of the urn 3 at a predetermined distance from the bottom wall 2 of the urn. The projection 6 serves to support and retain in place the nutrient transmission element 5 when the latter is placed in the interior space 4 of the urn 1. The presence of a projection 6 has the advantage that the nutrient transmission element 5 can be fixed in place parallel to and at a predetermined distance from the bottom wall 2. A further advantage of this embodiment is that the nutrient transmission element 5 can have a slightly smaller diameter than the internal diameter of the urn, therefore simplifying the insertion of the nutrient transmission element 5 into the interior space of the urn 4.

One disadvantage of the embodiment in accordance with FIG. 2b, however, is that the ash contained in the first chamber 7 may not reach the filling level of the projection 6, and that an empty space could thus be created between the ashes and the nutrient transmission element resting on the projection 6. In the event that such an empty space occurs, the transmission of nutrients between the ashes and the nutrient transmission element 5 is hindered. This drawback can be eliminated by the addition of more water. However, certain plant species are sensitive to an increase in water supply, and may perish.

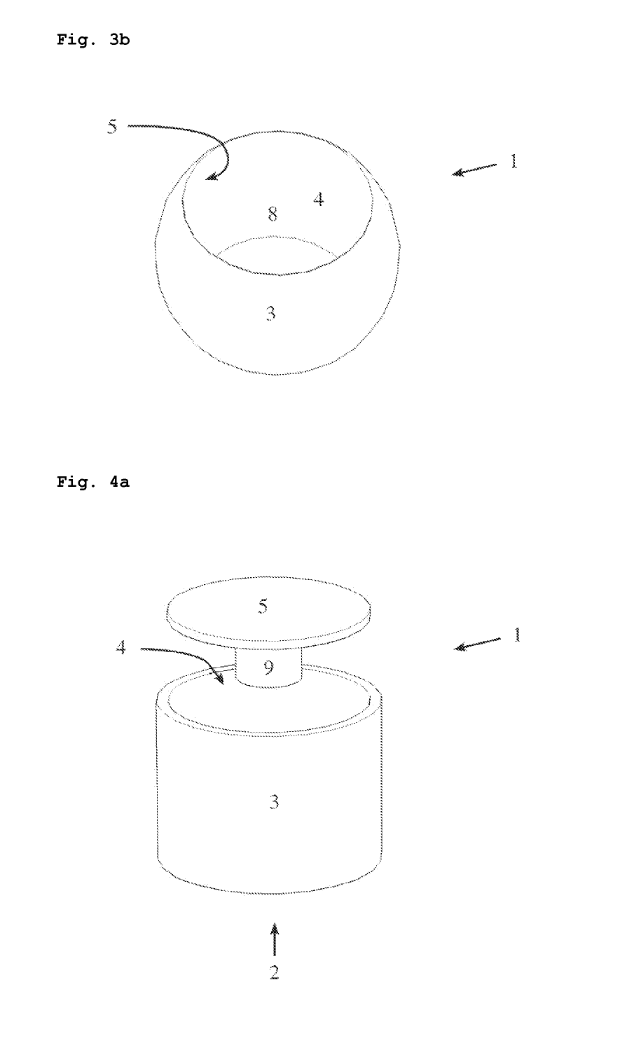

In a particularly advantageous embodiment of the urn in accordance with the invention in accordance with FIG. 3a, at least one additional nutrient transmission element is therefore arranged on the nutrient transmission element 5 as a wicking element 9.

FIG. 3a depicts a particular embodiment of the embodiment in accordance with the invention, in which the nutrient transmission element delimits the second chamber 8 of the urn, and separates it from the first chamber 7 of the urn. In the embodiment in accordance with FIG. 3a, the urn 1 is preferably formed so as to be essentially spherical, and has in its interior the nutrient transmission element 5, which is preferably formed so as to be hollow and cylindrical or prismatic and is open to the top side of the urn 1, with the lateral walls of the nutrient transmission element terminating against the inner side of the exterior wall 3 of urn 1 so as to be rigidly attachable. The first chamber 7 of the urn is formed by the cavity thus created between the exterior wall 3 of the urn 1 and the nutrient transmission element 5 in the interior space 4 of the urn 1.

FIG. 3b depicts an exterior view of the urn as in FIG. 3a.

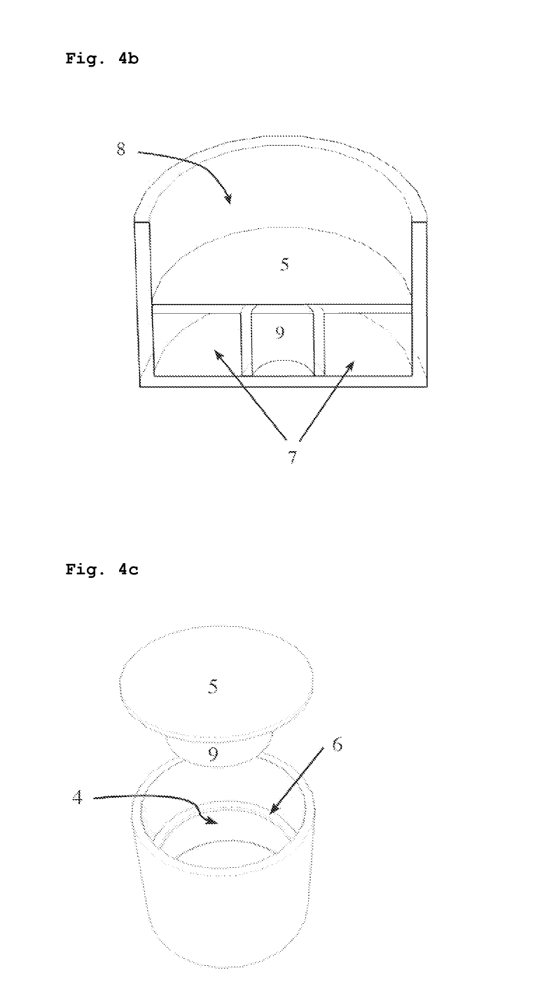

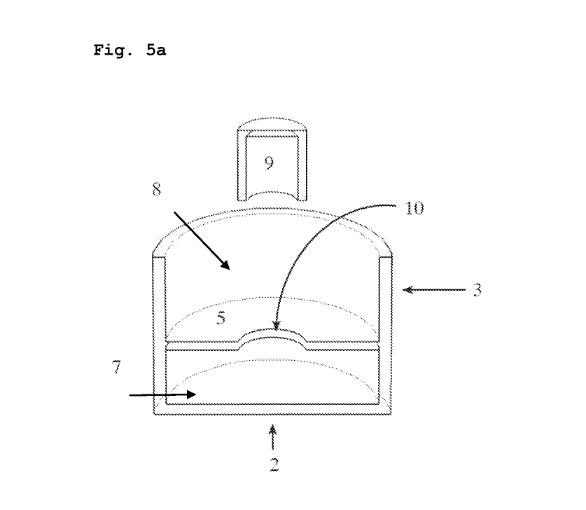

FIG. 4a shows in this regard a preferred embodiment of the urn 1 in accordance with the invention having an exterior wall 3. The nutrient transmission element 5 has a wicking element 9 which is arranged on the side of the nutrient transmission element 5 facing the first chamber 7. In a further especially advantageous embodiment, the wicking element 9 may be rigidly attached to the nutrient transmission element 5.

FIG. 4b depicts a cross-section of the embodiment in accordance with FIG. 4a with nutrient transmission element 5 inserted. This creates the two chambers 7 and 8. One particular advantage of this embodiment is that the distance between the nutrient transmission element 5 and the bottom wall 2 can be determined by the height of the wicking element 9. The projection 6 is then not strictly necessary in order to position the nutrient transmission element 5 at a predetermined, fixed distance from the bottom wall 2. An additional advantage of this embodiment is that the transportation of nutrients into the second chamber 8 by the wicking element 9 that extends into the ashes is ensured, regardless of the fill level of the ashes placed in the first chamber 7.

FIG. 4c shows a further preferred embodiment of the urn in accordance with the invention, in which a disc-shaped nutrient transmission element can be rigidly attached to a wicking element 9, and in which the nutrient transmission element 5 rests on and can be fixed in place by means of a projection 6, which extends radially at a predetermined distance from the bottom wall 2 of the urn along the inner side of the exterior wall 3 of the urn.

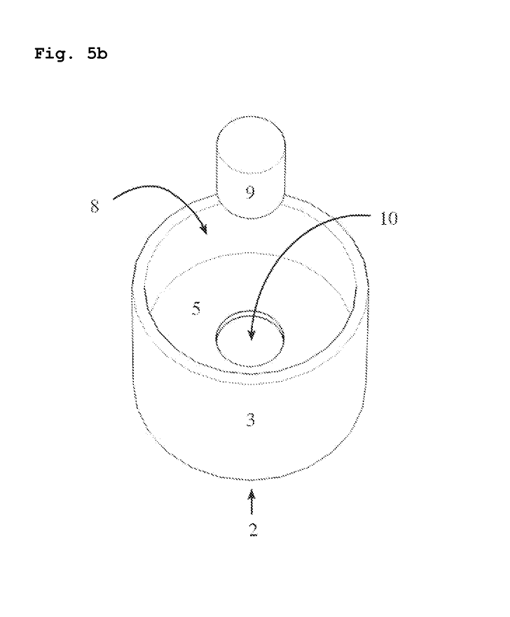

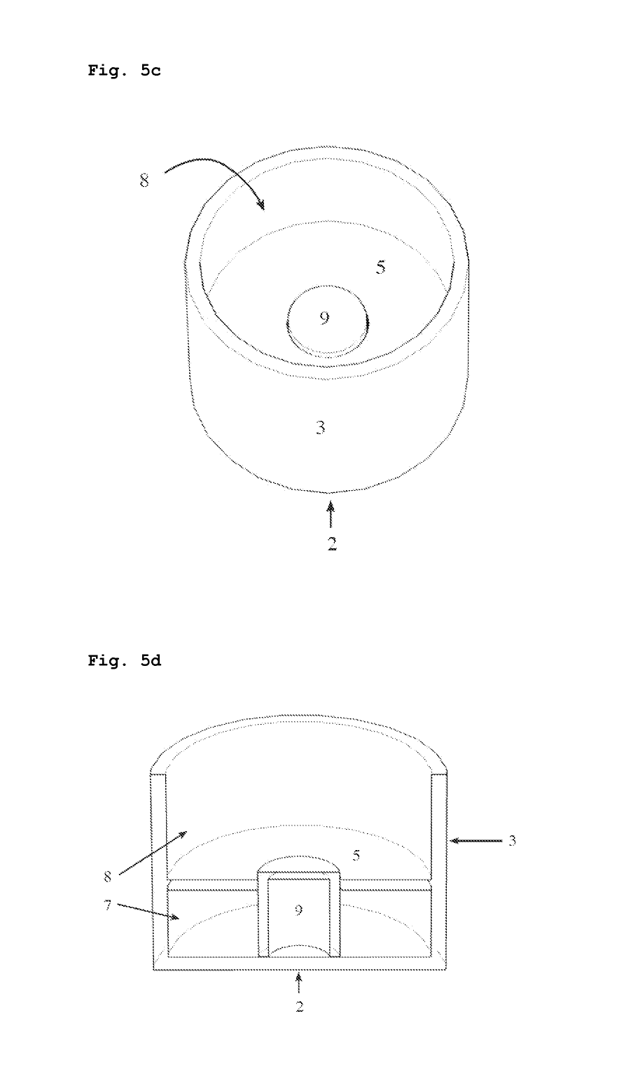

FIG. 5a depicts another advantageous embodiment of the urn 1 in which the nutrient transmission element 5 has at least one opening 10. In this embodiment, the nutrient transmission element 5 can be rigidly connected to the interior space 4 of the exterior wall 3 of the urn at a specific height. In a further embodiment of the urn in accordance with the invention, the nutrient transmission element 5 is placed in the urn only after the first chamber 7 has been filled with ashes. The opening 10 of the at least one nutrient transmission element 5 is formed such that it can firmly hold a wicking element 9; after insertion into the opening 10, the wicking element 9 projects into both the first chamber 7 and the second chamber 8. The nutrient transmission element 5 and the wicking element 9 held therein completely separate in this embodiment the first chamber 7 from the second chamber 8.

FIG. 5b shows a top view of the embodiment in accordance with FIG. 5a, in which the nutrient transmission element 5 having an opening 10 is positioned in the urn 1.

FIG. 5c depicts a top view of the urn in accordance with FIG. 5a and the wicking element 9 fixedly inserted in the nutrient transmission element 5.

FIG. 5d shows a cross-section of the embodiment in accordance with FIG. 5a, in which the wicking element 9 is inserted in the nutrient transmission element 5.

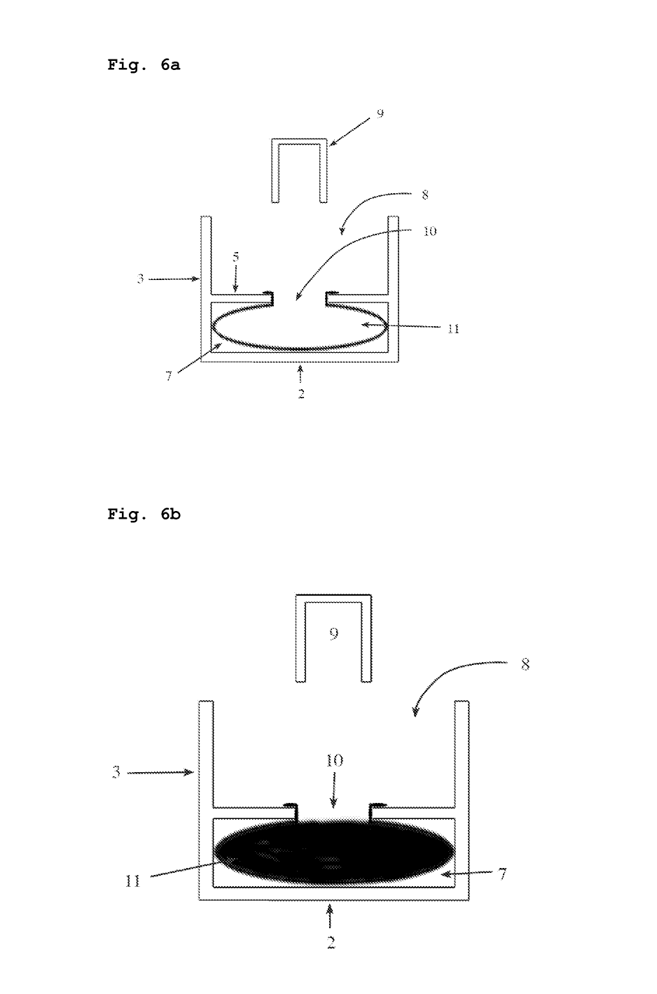

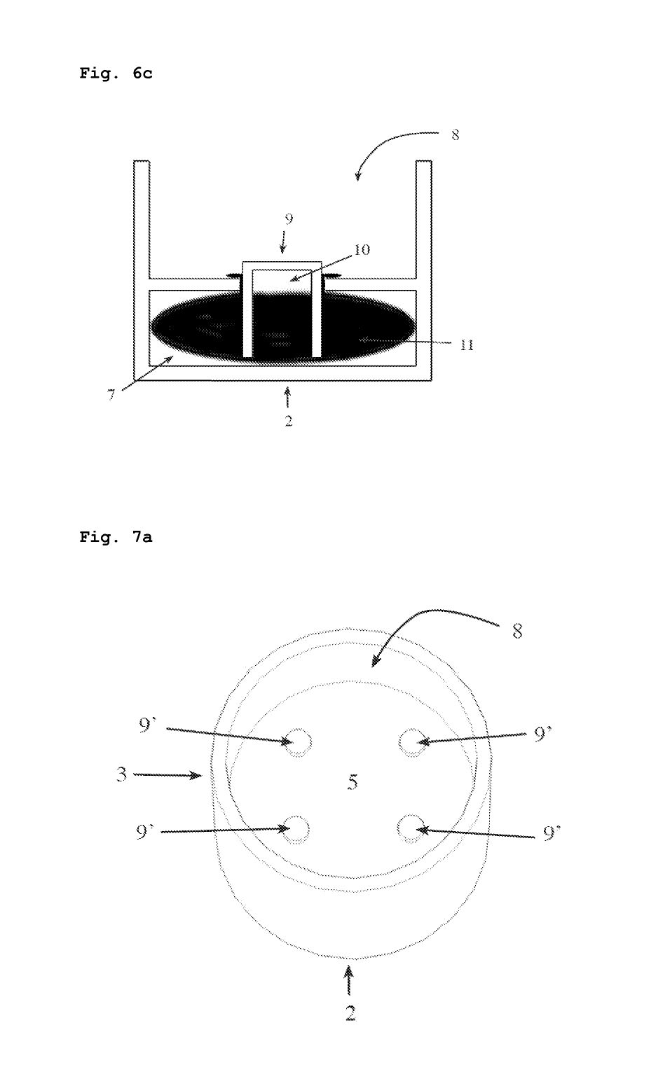

FIG. 6a depicts an embodiment of the urn in accordance with the invention in which the ashes are not placed directly in the first chamber 7, but rather in which an ash container 11 serving to contain the ashes is placed in the first chamber 7. This has the advantage that, in the event of damage to or the shattering of the urn, the ash remains contained by the ash container 11. The ash container 11 thus preferably consists of an insoluble substance or of another shatterproof material that permits moisture to seep in and allows the dissolved nutrients to penetrate into the first chamber 7. FIG. 6a shows the ash container 11 in its empty state in the first chamber 7 of the urn; the wicking element 9 is not inserted in the nutrition transmission element 5.

FIG. 6b depicts a full ash container 11 in the first chamber 7 of the urn 1.

FIG. 6c depicts the wicking element 9 inserted in the nutrient transmission element 5 and the ash container 11.

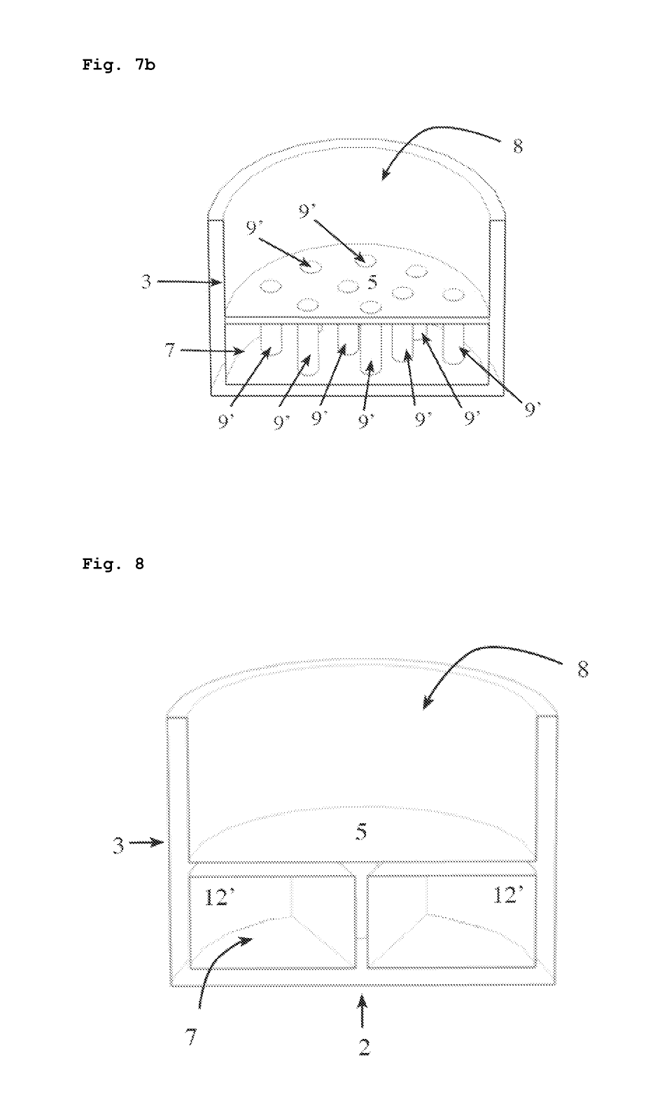

FIG. 7a shows the urn 1 in accordance with the invention, in which multiple wicking elements 9 are inserted in the nutrient transmission element 5. This has the advantage of improved nutrient transmission.

FIG. 7b shows a cross-section of the urn in accordance with the invention with multiple wicking elements 9 are inserted in the nutrition transmission element 5.

One especially advantageous embodiment of the urn in accordance with the invention provides that the ashes of multiple persons or animals can be contained in at least two partial chambers within the first chamber 7. FIG. 8 depicts the cross-section of an urn in accordance with the invention in which the first chamber 7 has at least two partial chambers 12.

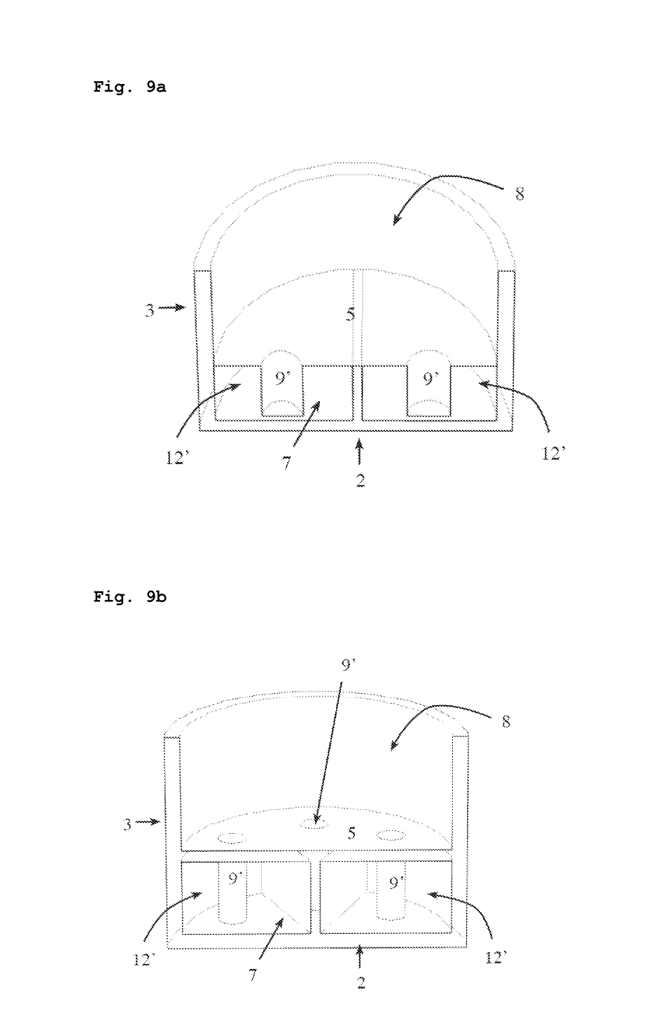

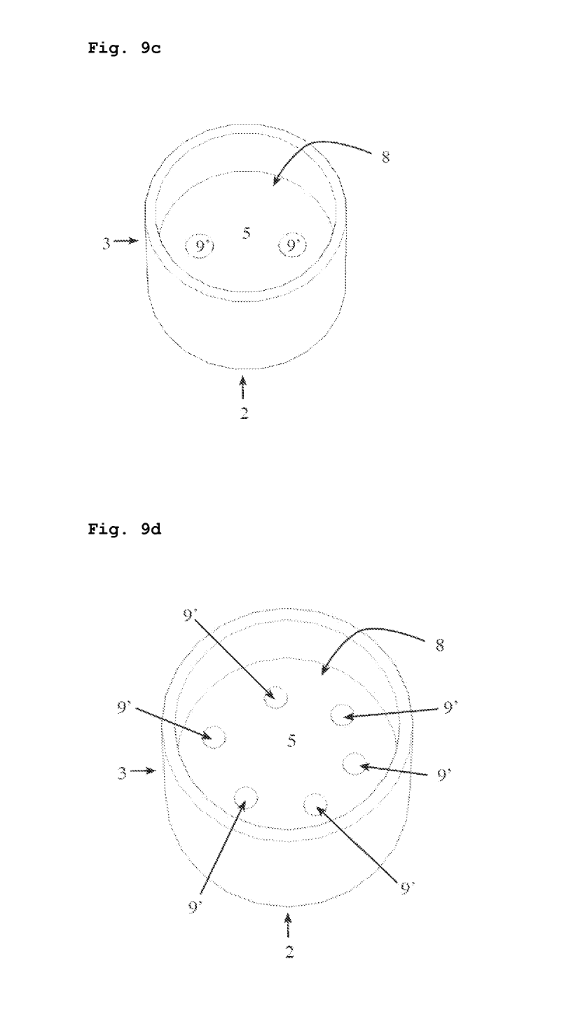

FIG. 9a shows an exemplary embodiment of the urn in accordance with the invention with two partial chambers 12′ and 12″, each having one wicking element.

FIG. 9b depicts the cross-section of an urn in accordance with the invention having six partial chambers, in which each partial chamber is assigned at least one wicking element 9 of its own.

FIG. 9c shows a top view of the urn in accordance with FIG. 9a.

FIG. 9d depicts a top view of the urn in accordance with FIG. 9b.

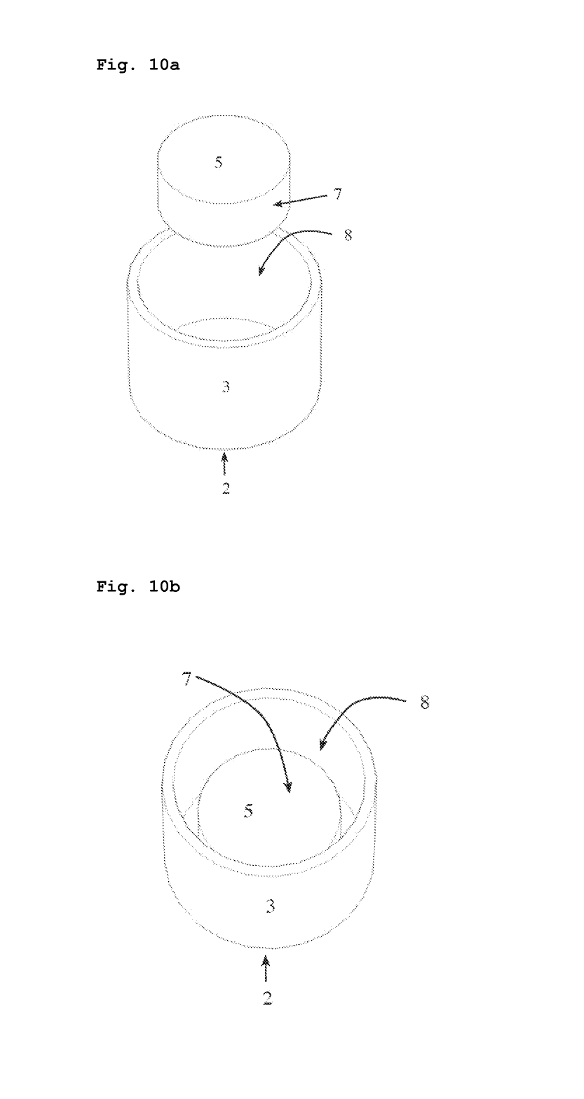

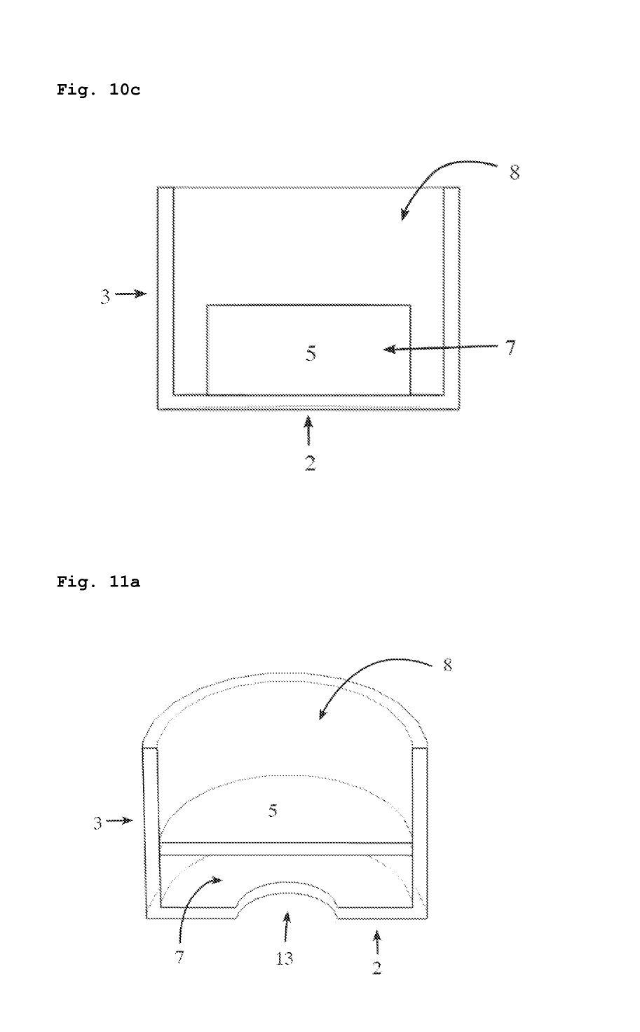

FIG. 10a shows an urn in accordance with the invention with a nutrient transmission element 5 that forms and delimits the first chamber 7 of the urn. The nutrient transmission element 5 is fully inserted into the interior space 4 of the urn 1. The interior space 4 of the urn 1 is then filled with the planting matrix (earth, granulate, etc.). In this embodiment, the second chamber 8 of the urn 1 encompasses the interior space 4 of the urn 1.

FIG. 10b depicts a top view of the urn in accordance with the invention in accordance with FIG. 10a, in which the nutrient transmission element 5 is inserted in the interior space 4. FIG. 10c shows the cross-section of the urn in accordance with the invention with an inserted nutrient transmission element 5.

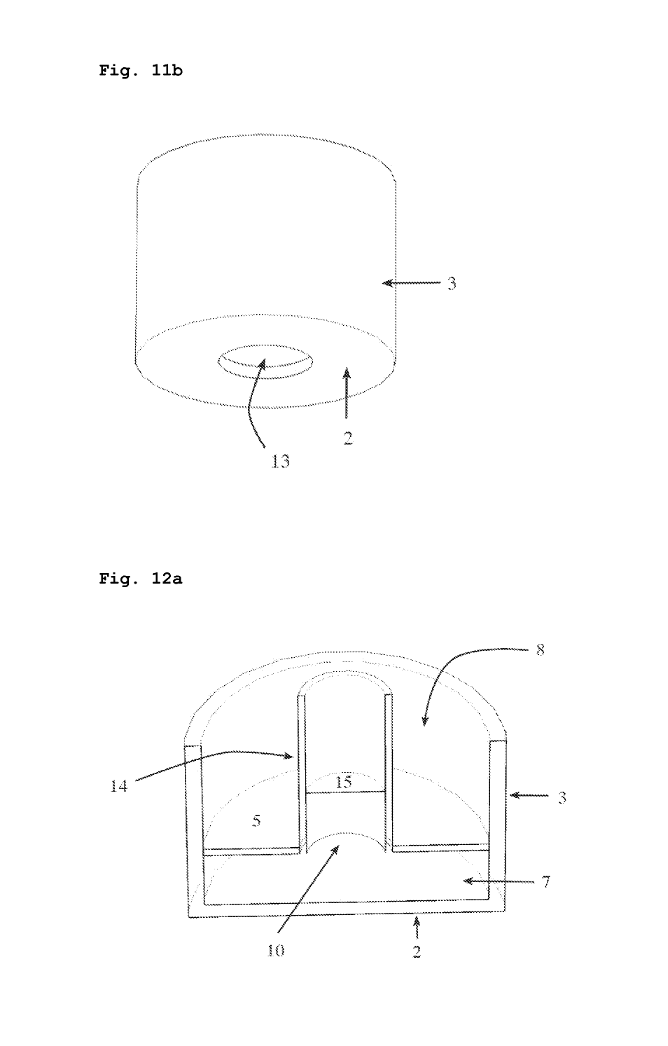

FIG. 11a shows a particular embodiment of the urn in accordance with the invention in which the first chamber 7 of the urn 1 can be filled with ashes through the bottom wall 2. In this embodiment, the bottom wall 2 has a sealable opening 13 through which the ashes can be inserted into the lower chamber 7 of the urn 1.

FIG. 11b shows a top view of an urn in accordance with FIG. 10a.

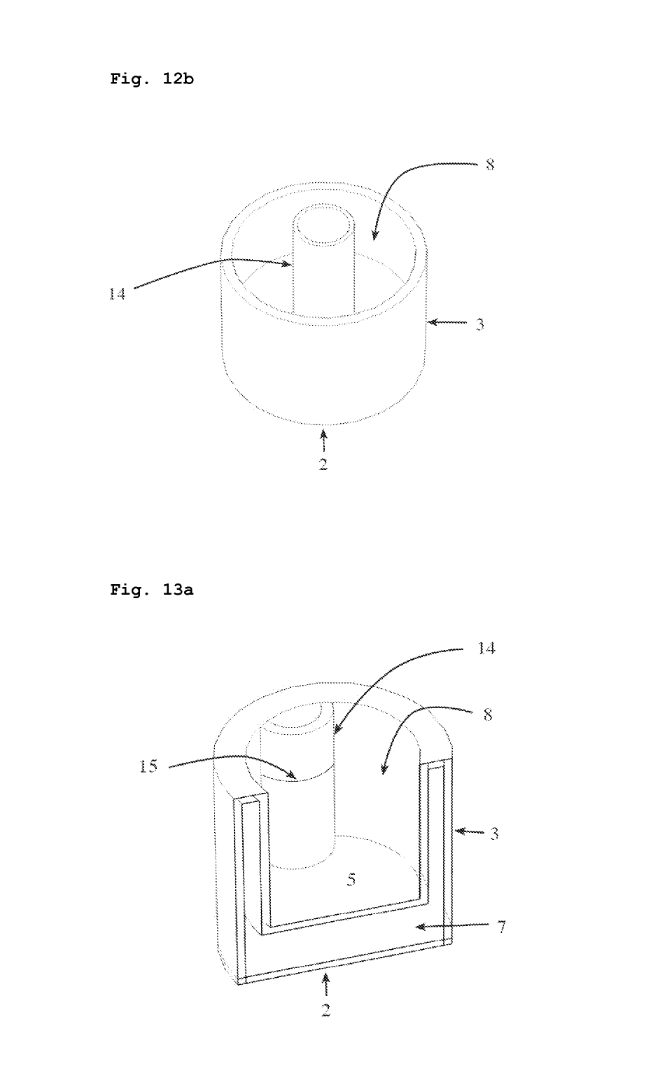

FIG. 12a depicts a further advantageous embodiment of the urn in accordance with the invention in accordance with FIG. 5a having an irrigating element 14. The irrigating element is preferably formed so as to extend lengthwise to the upper end of the interior space 4 of the urn. This is to prevent the movement of the planting matrix from the second chamber 8 of the urn into the first chamber 7.

In a particularly advantageous embodiment of the urn in accordance with FIG. 12a, a disc-shaped nutrient transmission element 5 which is arranged between the first chamber 7 and the second chamber 8 has at least one opening 10 with an irrigating element 14. The irrigating element 14 may be formed as a nutrient transmission element. The at least one irrigating element 14 may be connected to at least one additional nutrient transmission element 5.

In the depicted embodiment, the at least one irrigating element 14 is formed as a cylinder. However, the at least one irrigating element 14 may also have any other imaginable geometric form suited for separating the opening of the nutrient transmission element 10 or the first chamber 7 of the urn 1 from the second chamber 8 of the urn 1.

In this embodiment, the water for the plant is placed directly in the first chamber 7 of the urn, where the water is enriched with nutrients which are transported into the second chamber 8 of the urn 1 via at least one nutrient transmission element 5, 14.

One advantage of this embodiment is that this urn requires very little care and maintenance. It is sufficient that the water be topped up every few days. The risk that the plant will die if no water is provided for several days is lower with this system.

The opening of the nutrient transmission element 10 or the irrigating element 14 is preferably closeable in this embodiment of the urn 1, e.g. by means of a closure 15. This closure may have any conceivable geometric form, such as disc-shaped, cylindrical, or funnel-shaped. The closure serves to create a spatial separation between the first chamber 7 of the urn 1 and the second chamber 8 of the urn 1 or the external space of the urn 1. The closure 15 may be designed so as to be water-permeable, or may be formed so as to be capable of being opened for watering the plant and then closed again. The closure 15 is preferably a water-permeable membrane that prevents the ashes from escaping while simultaneously enabling water to enter the urn. If the closure 15 is located in the irrigating element 14, the latter is formed such that a penetration of the closure 15 into the first chamber 7 of the urn is prevented, e.g. by means of a narrowing of the irrigating element at a predetermined position.

FIG. 12b shows an external view of an urn in accordance with FIG. 12a.

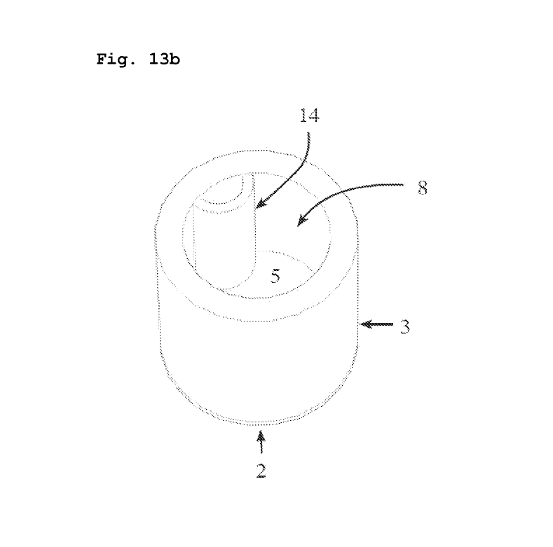

FIG. 13a depicts a particular embodiment of an urn in which the first chamber 7 of the urn is formed by a cavity between the exterior wall 3 of the urn 1 and the interior space 4 of the urn 1.

Preferably, at least one nutrition transmission element 5 here forms an inner side of the exterior wall 3 of the urn, and thus delimits the first chamber 7 from the second chamber 8 of the urn 1. In this advantageous form, the second chamber 8 forms the interior space 4 of the urn 1. In the embodiment of the urn in accordance with the invention in accordance with FIG. 13a, water can be conveyed into the first chamber 7 of the urn 1 e.g. by means of a irrigating element 14. If water is filled in the first chamber 7, nutrients are dissolved out of the ashes and transported into the second chamber 8 in the interior space 4 of the urn by means of at least one nutrient transmission element 5, 14.

FIG. 13b shows a top view of the urn in accordance with FIG. 13a.

### REFERENCE SIGNS

1 Urn
2 Bottom wall
3 Exterior wall of urn
4 Interior space of urn
5 Nutrient transmission element
6 Projection
7 First chamber
8 Second chamber
9 Wicking element
10 Opening in nutrient transmission element
11 Ash container
12 Partial chamber
13 Opening in bottom wall
14 Irrigating element
15 Closure

1-11. (canceled)

12. An urn and planter assembly, comprising:
a first chamber configured to receive cremation ashes;
a second chamber configured to receive a planting matrix; and
at least one nutrition transmission element arranged between the first chamber and the second chamber,
wherein nutrients can pass through the at least one nutrient transmission element from the first chamber into the second chamber.

13. The urn and planter assembly as in claim 12, wherein the first chamber comprises at least two partial chambers.

14. The urn and planter assembly as in claim 12, wherein the at least one nutrient transmission element is disc-shaped.

15. The urn and planter assembly as in claim 12,
wherein the urn and planter assembly comprises a bottom wall and an exterior wall extending upwardly from the bottom wall,
wherein the at least one nutrient transmission element is held in position at a predetermined distance from the bottom wall by one or more projections extending inwardly on the inner side of the exterior wall.

16. The urn and planter assembly as in claim 12,
wherein the urn and planter assembly comprises a bottom wall and an exterior wall extending upwardly from the bottom wall, and
wherein the at least one nutrient transmission element is fixedly connected to the inner side of the exterior wall.

17. The urn and planter assembly as in claim 12, wherein the at least one nutrient transmission element comprises a wicking element that extends into at least the first chamber.

18. The urn and planter assembly as in claim 12,
wherein the first chamber comprises a bottom wall, and
wherein the cremation ashes can be can be inserted into the first chamber through at least one opening in the bottom wall.

19. The urn and planter assembly as in claim 12, wherein the at least one nutrition transmission element comprises an irrigating element which is connected to the first chamber.

20. The urn and planter assembly as in claim 12, wherein the first chamber is formed on the inner side between a bottom wall, an exterior wall, and the at least one nutrient transmission element.

21. The urn and planter assembly as in claim 12, wherein the at least one nutrient transmission element surrounds the first chamber, and wherein the first chamber is arranged within the second chamber.

22. The urn and planter assembly as in claim 12, further comprising an ash container arranged within the first chamber.

23. An urn and planter assembly, comprising
an interior space formed between a bottom wall and an exterior side wall;
a first chamber formed within the interior space and configured to receive cremation ashes;
a second chamber formed separately from the first chamber within the interior space and configured to receive a planting matrix; and
at least one nutrition transmission element arranged between the first chamber and the second chamber, the at least one nutrient transmission element being configured to allow nutrients to pass from the first chamber into the second chamber.

24. The urn and planter assembly as in claim 23, wherein the first chamber and the second chamber are separated from one another by the nutrition transmission element.

25. The urn and planter assembly as in claim 24, wherein the first chamber is arranged below the second chamber and wherein the nutrition transmission element comprises a downwardly extending wicking element.

26. The urn and planter assembly as in claim 23, wherein the first chamber is divided into two or more sub-chambers.
